(19) United States
(12) Patent Application Publication
(10) Pub. No.: US 2026/0340166 A1
(43) Pub. Date: Oct. 29, 2026

(54) DATA ACCESS SYSTEM, CLIENT APPARATUS, DATA ACCESS METHOD AND PROGRAM

(71) Applicant: NIPPON TELEGRAPH AND TELEPHONE CORPORATION, Tokyo (JP)

(72) Inventor: Atsunori ICHIKAWA, Tokyo (JP)

(73) Assignee: NIPPON TELEGRAPH AND TELEPHONE CORPORATION, Tokyo (JP)

(21) Appl. No.: 19/117,755

(22) PCT Filed: Oct. 7, 2022
(86) PCT No.: PCT/JP2022/037721

§ 371 Date: Apr. 2, 2025

(51) Int. Cl. G06F 21/62

(52) U.S. Cl. CPC G06F 21/6218

(57) ABSTRACT

By comprising: a node acquisition unit configured to acquire all nodes ranging from a root node of a complete binary tree to any one of leaf nodes, from a server device that has the complete binary tree capable of storing data in each node and randomly storing all data in any leaf node in an initial state; a selection unit configured to select data to be accessed probabilistically from each of the all nodes and delete the data from the node; a moving unit configured to probabilistically move data selected by the selection unit to any of nodes ranging from the root node to the leaf node out of the all nodes, and probabilistically move data not selected by the selection unit to any of nodes ranging from a node storing the data to the leaf node; and a node reply unit configured to reply the all nodes to which data are moved, to the server device in order to reflect the all nodes on the complete binary tree, the spatial efficiency for keeping the contents regarding access to data secret from the server, can be improved.

### TECHNICAL FIELD

The present invention relates to a data access system, a client device, a data access method, and a program.

### BACKGROUND ART

An ORAM (Oblivious RAM (Random Access Machine)) is a technique that enables a client to safely deposit data to an external server and access the data as needed. According to the ORAM, not only the data can be retrieved and referred simply while being encrypted, but also the retrieval history and the deviation (access pattern) of the retrieval can be concealed from the server, so that high safety can be realized. Some derivation techniques exist in the ORAM, and for example, derivation called simple ORAM is a kind of ORAM having excellent spatial efficiency. Specifically, when the original data set consists of B-bit data by N (total NB bits), while an ordinary ORAM requires a memory area having NB (1+Θ(1)) bits on the server side, NB (1+o(1)) bits are sufficient for the simple ORAM.

Another derivative is a technique called a RORAM (Random-Index ORAM) (NPL 1). The ordinary ORAM and the simple ORAM are defined as a function for acquiring desired data by explicitly specifying data to be accessed by a client (for example, a retrieval key or the like uniquely associated with the data is used for inputting a protocol) in data access. The RORAM, on the other hand, is defined such that the client does not specify data in the case of data access, but instead acquires random data (one or a plurality of pieces of data) from the data held by the server. In view of this property, the RORAM is difficult to use like an encrypted database, but instead, the RORAM is a technique that is expected to be utilized for safe random sampling and large-scale multi-party calculation for large-scale data.

### CITATION LIST

### Non Patent Literature

[NPL 1] Halevi, S. and Kushilevitz, E.: Random-Index Oblivious RAM, Cryptology ePrint Archive (2022).

### SUMMARY OF INVENTION

### Technical Problem

Since the RORAM does not require such requirement as “search for correct data from a search key” of the ordinary ORAM, many processes required in the ORAM can be omitted. Therefore, it is expected that the time efficiency and spatial efficiency can be reduced more than those of the ORAM, but in actuality, there is a current situation in which the reduction remains very little.

The present invention has been made in view of the points described above, and an object thereof is to improve the spatial efficiency for keeping the contents regarding access to data secret from the server.

### Solution to Problem

In order to solve the above problem, in a data access system that includes a server device that has a complete binary tree capable of storing data in each node and randomly storing all data in any leaf node in an initial state, and a client device for accessing the data, the client device has: a node acquisition unit configured to acquire all nodes ranging from a root node of the complete binary tree to any one leaf node, from the server device; a selection unit configured to select data to be accessed probabilistically from each of the all nodes and delete the data from the node; a moving unit configured to probabilistically move data selected by the selection unit to any of nodes ranging from a root node to the leaf node out of the all nodes, and probabilistically move data not selected by the selection unit to any of nodes ranging from a node storing the data to the leaf node; and a node reply unit configured to reply the all nodes to which data are moved, to the server device in order to reflect the all nodes on the complete binary tree.

### Advantageous Effects of Invention

It is possible to improve the spatial efficiency for keeping the contents regarding access to data secret from the server.

### BRIEF DESCRIPTION OF DRAWINGS

FIG. 1 is a diagram showing a configuration example of a data access system according to an embodiment of the present invention.

FIG. 2 is a diagram showing an example of a hardware configuration of a server device 10 according to an embodiment of the present invention.

FIG. 3 is a diagram showing an example of functional configurations of the server device 10 and a client device 20 according to an embodiment of the present embodiment.

FIG. 4 is a diagram for explaining a height u and a position t.

FIG. 5 is a sequence diagram for explaining an example of a processing procedure of data access processing executed by the server device 10 and the client device 20.

### DESCRIPTION OF EMBODIMENTS

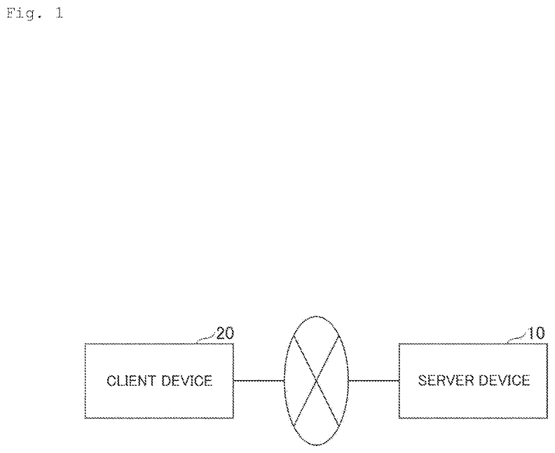

Hereinafter, embodiments of the present invention will be described with reference to the drawings. FIG. 1 is a diagram showing a configuration example of a data access system according to an embodiment of the present invention. In FIG. 1, the data access system includes a server device 10 and a client device 20. The server device 10 and the client device 20 are connected to each other via a network such as a LAN (Local Area Network) or the Internet.

The server device 10 is one or more computers that manage data.

The client device 20 is a computer for accessing data.

A plurality of server devices 10 may be present, or a plurality of client devices 20 may be present.

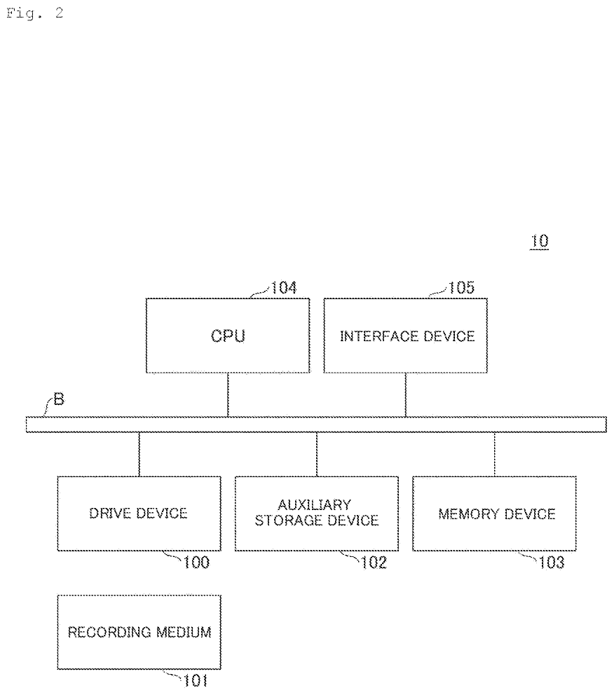

FIG. 2 is a diagram showing an example of a hardware configuration of the server device 10 according to an embodiment of the present invention. The server device 10 shown in FIG. 2 includes a drive device 100, an auxiliary storage device 102, a memory device 103, a CPU 104, and an interface device 105, which are connected with each other via a bus B.

A program for realizing processing in the server device 10 is provided by a recording medium 101 such as a CD-ROM. When the recording medium 101 with the program stored therein is set in the drive device 100, the program is installed from the recording medium 101 to the auxiliary storage device 102 via the drive device 100. However, the program does not necessarily have to be installed from the recording medium 101 and may be downloaded from another computer via a network. The auxiliary storage device 102 stores the installed program as well as necessary files, data, and the like.

The memory device 103 reads and stores the program from the auxiliary storage device 102 when an instruction for starting the program is issued. The CPU 104 executes the functions pertaining to the server device 10 in accordance with the program stored in the memory device 103. The interface device 105 is used as an interface to connect to the network.

Note that the client device 20 also has the hardware configuration shown in FIG. 2.

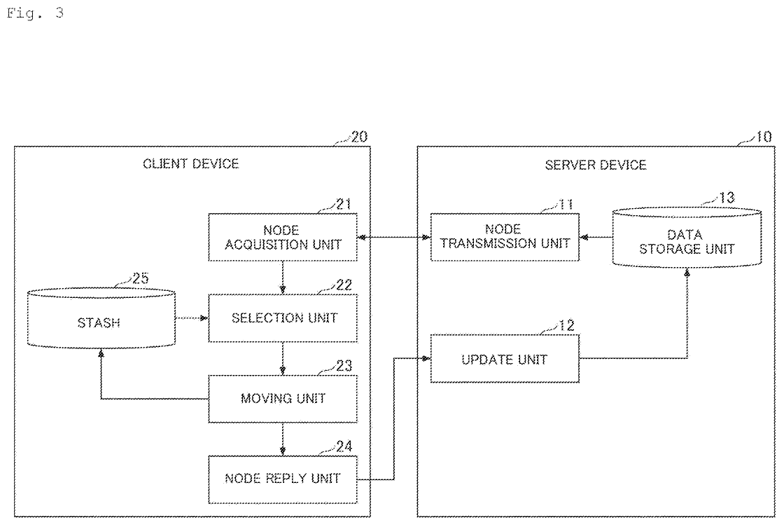

FIG. 3 is a diagram showing an example of functional configurations of the server device 10 and the client device 20 according to the present embodiment.

In FIG. 3, the server device 10 has a node transmission unit 11 and an update unit 12. These respective units are implemented through processing that one or more programs installed on the server device 10 causes the CPU 104 to execute. The server device 10 also uses a data storage unit 13. The data storage unit 13 can be implemented by using, for example, the auxiliary storage device 102, a storage device that can be connected to the server device 10 via the network, or the like.

On the other hand, the client device 20 has a node acquisition unit 21, a selection unit 22, a moving unit 23, and a node reply unit 24. These respective units are implemented through processing that one or more programs installed on the client device 20 causes the CPU of the client device 20 to execute. The client device 20 may also use a stash 25 as needed. The stash 25 can be implemented by using, for example, an auxiliary storage device or memory device of the client device 20, or a storage device which can be connected to the client device 20 via the network.

Here, it is assumed that f and g are defined as the following functions.

f(x)=ω(log x) and f(x)=O(log² x),g(x)=ω(1) and g(x)=o(\sqrt{f(x)/log x}) [Math. 1]

The following expression is satisfied, where N represents the total number of pieces of data and Z a constant.

$$L = ⌈ log \frac{N}{f ( N )} ⌉ , M = ⌈ \frac{N}{{2}^{L}} + g ( N ) \sqrt{\frac{NL}{{2}^{L}}} ⌉ \qquad [ Math . 2 ]$$

The data storage unit 13 has a data structure expressed by a complete binary tree having a height L (simply referred to as “binary tree,” hereinafter), and stores N pieces of data by using the binary tree. However, 2^{L}−1 internal nodes among binary tree nodes are capable of storing up to a maximum of Z pieces of data, and 2^{L} leaf nodes are capable of storing up to a maximum of M pieces of data. In principle, each piece of data is stored in any of the nodes, and in doing so, one-bit auxiliary information is given to each piece of data d.

In an initial state, all pieces of data d are randomly stored in any leaf node as a pair (d, 0), with the auxiliary information c=0.

The client device 20 and the server device 10 each have a query counter ctr. An initial value of the ctr is 0 and is incremented (1 is added) each time access is performed.

The stash 25 is a storage unit (arrays) for temporarily storing data that have probabilistically overflowed from the binary tree in terms of probability. A height u and a position t in addition to the auxiliary information c are given to each piece of data d stored in the stash 25, by the client device 20, as auxiliary information. Here, the height u and the position t given to certain data d are identification information (height and position) of a node of the binary tree nodes in which the data d cannot be stored because of the overflow of the volume thereof, although the data d is scheduled to be stored.

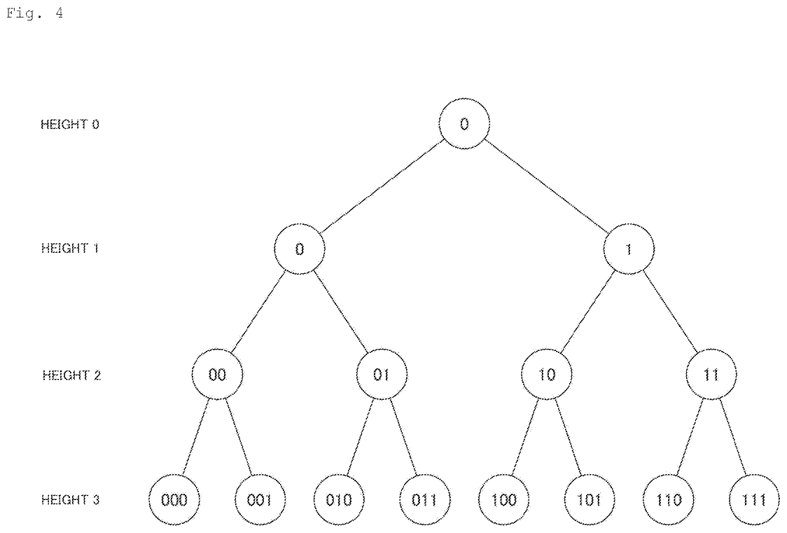

FIG. 4 is a diagram for explaining the height u and the position t. A complete binary tree with height L=3 is illustrated in FIG. 4.

The height u of a certain node is counted with the root set to 0. Therefore, the height of a leaf node is L (L=3 in FIG. 4).

The position t of a certain node is, for example, a value (serial number) indicating where the position is from the left at the height to which the node belongs. In this case, the position t allocated to each node at the height u is within the range of 0, . . . , 2^{b}−1. In FIG. 4, for convenience, the value of the position t is expressed in a binary number and described in each node.

Since two or more pieces of data d may be allocated to the same node, the height u and the position t may probabilistically overlap between the data d in the stash 25.

It is assumed that in the initialization, all the N pieces of data d are stored randomly in any leaf node, and that at the time of the initialization, the server device 10 does not have information on the arrangement of the data d. Examples of a method of realizing this include a method of distributing the data d to leaves by using a secret shuffle protocol (reference [4]) between the client device 20 and the server device 10, but other arbitrary methods may be adopted if they have the same properties. Note that the literature information of each reference will be described later.

The number of bits of a server memory area required for this data d structure is as follows and is simple at any B.

$$NB ( 1 + Θ ( \frac{1}{f ( N )} + \frac{g ( N )}{\sqrt{f ( N ) / log N}} ) ) \qquad [ Math . 3 ]$$

B represents the number of bits of the data d.

Hereinafter, a processing procedure (protocol) to be executed by the server device 10 and the client device 20 when accessing the data d will be described. Although omitted for the sake of simplicity, hereinafter, it is assumed that all pieces of the data d on the server device 10 are encrypted by a secret key of the client device 20, and that an encrypted text associated with re-encryption is re-randomized every time the client device 20 acquires and returns the data d. The same processing may be performed as multi-party calculation by three or more server devices 10 instead of the two-party protocol between the client device 20 and the server device 10.

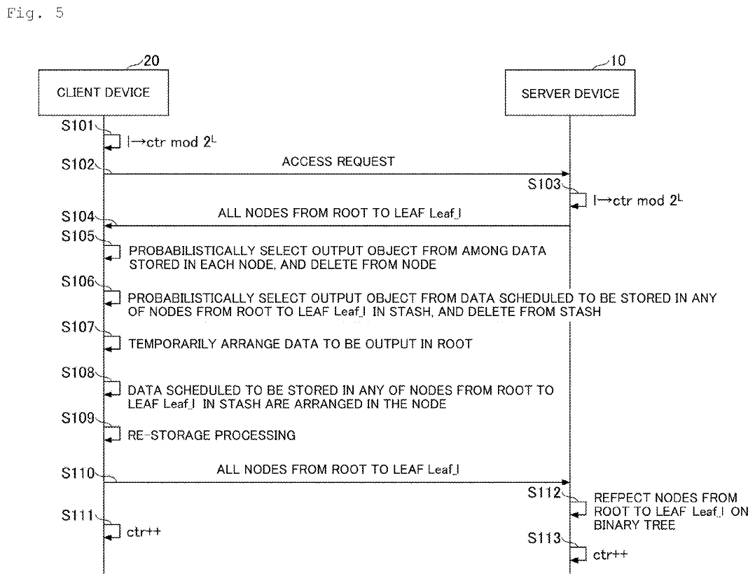

FIG. 5 is a sequence diagram for explaining an example of a processing procedure of processing for accessing the data d that is executed by the server device 10 and the client device 20.

In accessing data, the node acquisition unit 21 of the client device 20 substitutes a bit inversion value of the value of L bit which is a remainder (ctr mod 2^{L}) obtained by dividing the ctr by 2^{L} into 1 (S101). The number of bits in 1 is also L. Therefore, the range that the ctr mod 2^{L} can take is 0 to 2^{L}−1. Similarly, the range that 1 can take is also 0 to 2^{L}−1. This range coincides with the range of the position t of the leaf node in the binary tree.

Then, the node acquisition unit 21 transmits an access request for accessing data to the server device 10 (S102). Here, the data d to be accessed are not designated. This is because the data d to be accessed are random in the RORAM which is assumed in the present embodiment.

The node transmission unit 11 of the server device 10 substitutes the inversion value of the remainder obtained by dividing the ctr by 2^{L} into 1 in response to the access request for accessing data (S103). The value of the ctr is common between the client device 20 and the server device 10. Therefore, the number of bits and value of 1 are also common between the client device 20 and the server device 10.

Subsequently, the node transmission unit 11 transmits, to the client device 20, all of L nodes on the shortest path (simply referred to as “path,” hereinafter) from the root of the binary tree to one 1-th leaf node (i.e., the position described in FIG. 4 is 1) in the leaf nodes, in the data storage unit 13 (S104). The range of the positions of the leaf nodes of the binary tree is 0, . . . , 2^{L}−1. In the following, these leaves may be expressed as Leaf_0, . . . , Leaf_{2^{L}−1}. In this case, the 1-th leaf node is Leaf_1.

When upon receiving nodes from the root node to Leaf_1, the node acquisition unit 21 of the client device 20 sets the nodes in the order of N₀, . . . , N_{L}.

Then, for the data d stored in each node, the selection unit 22 selects the data d to be output, by determining whether or not the data d to be output is taken probabilistically as an object to be output (object to be accessed) in consideration of the number of leaf nodes associated with the node (i.e., the number of paths to which the node belongs among paths from the root node to each leaf node in the binary tree (hereinafter, “the number of belonging paths”)), and deletes the selected data d from the node (S105). Specifically, the selection unit 22 sets all data d (d, c) stored in Nᵢ as an output object at a probability of ½^{L-i-c}, and removes the data d to be output, from the Nᵢ.

The following describes the reason for setting the output object at the probability of ½^{L-i-c}.

In the existing technology, each piece of data d is set to be “randomly associated with any leaf (path to which the leaf belongs) from Leaf_0 to Leaf_{2^{L}−1},” and satisfies the fact that “when the data d is associated with Leaf_1, d is present in any node on the path between the root and the Leaf_1.”

In the present embodiment, the spatial efficiency is improved by eliminating the direct association between the data d and the Leaf_1 (the Leaf_1 is not saved in association with each piece of data d.).

In this case, in order to emulate an effect equivalent to that of the existing technology, the data d existing at the height i is “associated with any of the 2^{L}−1 leaves on the path to which the node N₁ for potentially storing the data d belongs,” and the probability ½^{L-i} associated with one of the leaves (Leaf_1 during reading) is defined as a condition of output determination. That is, the higher the number of associated leaf nodes in a node (i.e., the closer the to the root node in the binary tree), the lower the output probability of the data stored in the node.

However, the movement of the data d with c=1 to a sub-node of a height i+1 is determined (by the action of (a) in step S109 to be described later), and the number of candidates of leaves as the progeny of the sub-node is 2^{L-i-1}. Thus, in the present embodiment, the output probability is set to ½^{L-i-c}.

Subsequently, for each piece of data d schedule to be stored in any of the nodes N₀, . . . , N_{L} acquired from the server device 10 in the current access among all data d (d, c, u, t) stored in the stash 25, the selection unit 22 determines whether or not the each piece of data d is probabilistically an object to be output (object to be accessed) in consideration of the number of leaf nodes associated with a node in which the each piece of data d is scheduled to be stored (i.e., the number of belonging paths to which the node belongs), selects data d to be output, and deletes the selected data d from the stash 25 (S106).

Specifically, the selection unit 22 sets data in which a higher-order u bit of 1 matches t among all the data (d, c, u, t) stored in the stash 25, as an object to be output at a probability of ½^{L-u-c}, and removes the data to be output from the stash 25. The concept of the probability (output probability) is the same as the output probability ½^{L-i-c}. That is, the probability is determined in consideration of the number of leaf nodes (the number of belonging paths to which the node belongs) associated with the node scheduled to store the data d. More specifically, the output probability becomes lower as the number of leaf nodes associated with the node in which data is scheduled to be stored increases (the more the belonging paths the node has).

The higher-order u bit of 1 matches the position t of an ancestor node at the height u among the ancestor nodes of Leaf_1 (the 1-th leaf node). For example, referring to FIG. 4, when 1 is “011,” {0, 0, 01, 011} is a node on the path from the root to the Leaf_1, in which case the serial number of the node at a height 2 is “01” which is the higher-order 2 bits of 1. Similarly, the serial number of height 1 is “0’ which is the higher-order 1 bit of 1. In this way, the higher-order u bit of 1 indicates the t of the node with the height u among the ancestor nodes of the 1-th leaf node.

Therefore, the data in which the higher-order u bit of 1 matches t among all the data d (d, c, u, t) stored in the stash 25 coincides with t refers to the data scheduled to be stored in any of the nodes N₀, . . . , N_{L} acquired from the server device 10.

Then, the moving unit 23 sets c=0 for all data d selected as an output object in step S105 or S106, and temporarily arranges all the data d (d, 0) in the root N₀ (S107). In doing so, the selection unit 22 deletes (u, t) of the data d selected from the stash 25.

Then, when the remaining data (d, c, u, t) of the stash 25 have data in which the higher-order u+1 bit of 1 matches t (i.e., data scheduled to be stored in any of N₀, . . . , N_{L}), the moving unit 23 temporarily arranges (d, c) after removing (u, t) from the data (d, c, u, t) in an Nu (i.e., a node where the data is scheduled to be stored), and deletes the data from the stash 25 (S108).

Then, the moving unit 23 executes re-storage processing (data moving processing) constituted by the following procedures (a) to (c) (S109).

(a) First, all the data d where c=1 is moved to Nᵢ₊₁ in each Nᵢ; i<L (i.e., the node Nᵢ other than Leaf_1) among N₀, . . . , N_{L}, and c=0 is set in said data d. This step (a) is a process for moving data determined to be moved to a path different from the path acquired from the server device 10 at the time of access, to said path at the time of the past access. This will be apparent in the following steps.

(b) Subsequently, all data d with c=0 (also including the data d with c=0 in (a)) are moved to Nᵢ₊₁ at a probability ½. That is, movement of data d selected as an output object is started from N₀, and movement of data d not selected as an output object is started from Nᵢ (in a case where the data d is data stored in the stash 25, then Nᵢ where the data d is scheduled to be stored). This processing is executed one branch at a time in the direction of Leaf_1 until the movement of each piece of data d fails (i.e., when the movement does not occur at a probability of ½). When the movement of certain data d fails, c=1 is set at the timing at which the movement fails, and the data d is stored in a node to which the data d reaches at the time at which the movement fails (that is, when the number of successful movements is k, then Nᵢ₊ₖ). The data d which has reached the Leaf_1 (node N_{L}) is stored in the Leaf_1 with c=0.

The reason why the probability of movement to Nᵢ₊₁ is ½ is to equalize the probability of movement to each of two sub-nodes of the Nᵢ.

Here, the failure in the movement to the node Nᵢ₊₁ means that it is determined that the movement should be performed to the sub-node other than Nᵢ₊₁ out of the two sub-nodes of the node N₁ (i.e., a sub-node on a path of a leaf node other than the Leaf_1). Therefore, c=1 indicates that it was determined that the movement to another path was to be performed in the re-storage process but has failed. However, the data where c=1 can be moved to the sub-node on the other path by (a) at the time of access in the future.

(c) Finally, when there is data d which cannot be stored completely in each node Nᵢ (when there is data d moved to a node exceeding the capacity), u=i and the higher-order u bit of 1 is substituted into t (d, c, u, t) are stored in the stash 25. Here, i of Nᵢ is the height of Nᵢ. Therefore, substituting i into u is to substitute the height of Nᵢ into u. As described above, the higher-order u bit of 1 corresponds to the position of the node of the height u among the ancestor nodes of the Leaf_1. Therefore, substituting the higher-order u bit of 1 into t is to substitute the position of Nᵢ into t. That is, (u, t) of the data d which cannot be stored in the node Nᵢ is identification information (height, position) of the node Nᵢ.

Subsequently, the node reply unit 24 of the client device 20 returns all the nodes N₀, . . . , N_{L} to the server device 10 (S110) and adds 1 to the ctr (S111) in order to reflect the movement of the storage destination of the data to the server device 10 (binary tree of the data storage unit 13 of the server device 10).

Upon receiving the nodes N₀, . . . , N_{L}, the update unit 12 of the server device 10 substitutes (updates) a node corresponding to the nodes N₀, . . . , N_{L} in the binary tree in the data storage unit 13, with the received content (S112). As a result, the movement of data in the client device 20 is reflected in the binary tree. Next, the update unit 12 adds 1 to the ctr (S113).

As described above, according to the present embodiment, the spatial efficiency of the data structure can be improved as compared with the conventional RORAMs and ORAMs, with respect to the RORAMs capable of random access to large-scale data. That is, the spatial efficiency for keeping the contents regarding access to data secret from the server.

Specifically, the existing RORAM (reference [1]) requires a memory area NB (1+Θ(1)) similarly to a normal ORAM, whereas in the present embodiment, NB(1+o(1)) is sufficient, as with the simple ORAM (references [2], [3]). In addition, the present embodiment has more excellent spatial efficiency while achieving the same calculation efficiency as compared with those of the existing simple ORAM (reference [2]). Specifically, reference [2] requires the lower limit B=ω(log N) of the block size to satisfy the simplicity (i.e., the necessary space becomes NB(1+o(1))), whereas the present embodiment is simple with an arbitrary block size.

Note that B is the number of bits of data, and N is the number of pieces of data.

Although the embodiments of the present invention have been described in detail above, the present invention is not limited to such particular embodiments, and various modifications and changes are possible within the scope of the gist of the present invention described in the claims.

The literature information of the references described above are as follows.
[1] Goldreich, O. and Ostrovsky, R.: Software Protection and Simulation on Oblivious RAMs, J. ACM, Vol. 43, No. 3, pp. 431.473 (1996).
[2] Onodera, T. and Shibuya, T.: Succinct Oblivious RAM, STACS (2018).
[3] Riki Fukunari, Wakaha Ogata: Proposal of an extremely simple Oblivious RAM protocol, SCIS (2021).
[4] Patel, S., Persiano, G., and Yeo, K.: CacheShu.e: A family of oblivious shu.es, ICALP (2018)3

### REFERENCE SIGNS LIST

10 Server device
11 Node transmission unit
12 Update unit
13 Data storage unit
20 Client device
21 Node acquisition unit
22 Selection unit
23 Moving unit
24 Node reply unit
25 Stash
100 Drive device
101 Recording medium
102 Auxiliary storage device
103 Memory device
104 CPU
105 Interface device
B Bus

1. A data access system, comprising:
a server device that has a complete binary tree capable of storing data in each node and randomly storing all data in any leaf node in an initial state, and a client device for accessing the data,
wherein the client device:
acquires all nodes ranging from a root node of the complete binary tree to any one of leaf nodes, from the server device;
selects data to be accessed probabilistically from each of the all nodes and delete the data from the node;
moves data selected probabilistically to any of nodes ranging from the root node to the leaf node out of the all nodes, and probabilistically move data not selected to any of nodes ranging from a node storing the data to the leaf node; and
reply to the all nodes to which data are moved, to the server device in order to reflect the all nodes on the complete binary tree.

2. The data access system according to claim 1, wherein the a probability of selecting data stored in a node closer to the root node among the all nodes is reduced, as the data is accessed.

3. The data access system according to claim 1, wherein identification information of the node is added to data moved to a node exceeding a capacity, and the data is stored, as a result of a probabilistic movement of the data, and
selecting probabilistically, as data is accessed, data to which identification information of any of the all nodes acquired is added, from among the data stored, and delete the data to be accessed.

4. The data access system according to claim 3, wherein a probability of selecting data to which identification information of a node closer to the root node is added is reduced, among the data stored, as the data is accessed.

5. The data access system according to claim 1, wherein when a sub-node of a certain node together with another leaf node different from the leaf node is acquired, with respect to data that is not probabilistically moved successfully from said certain node, move said data probabilistically to any of nodes ranging from the sub-node to said other leaf node.

6. A client device comprising:
acquiring all nodes ranging from a root node of a complete binary tree to any one of leaf nodes, from a server device that has the complete binary tree capable of storing data in each node and randomly storing all data in any leaf node in an initial state;
selecting data to be accessed probabilistically from each of the all nodes and delete the data from the node;
probabilistically moving data selected to any of nodes ranging from the root node to the leaf node out of the all nodes, and probabilistically moving data not selected to any of nodes ranging from a node storing the data to the leaf node; and
replying all nodes to which data are moved, to the server device in order to reflect the all nodes on the complete binary tree.

7. A data access method for causing a computer to execute:
a node acquisition procedure for acquiring all nodes ranging from a root node of a complete binary tree to any one of leaf nodes, from a server device that has the complete binary tree capable of storing data in each node and randomly storing all data in any leaf node in an initial state;
a selection procedure for selecting data to be accessed probabilistically from each of the all nodes and deleting the data from the node;
a moving procedure for probabilistically moving data selected in the selection procedure to any of nodes ranging from the root node to the leaf node out of the all nodes, and probabilistically moving data not selected in the selection procedure to any of nodes ranging from a node storing the data to the leaf node; and
a node reply procedure for replying the all nodes to which data are moved, to the server device in order to reflect the all nodes on the complete binary tree.

8. A program for causing a computer to execute:
a node acquisition procedure for acquiring all nodes ranging from a root node of a complete binary tree to any one of leaf nodes, from a server device that has the complete binary tree capable of storing data in each node and randomly storing all data in any leaf node in an initial state;
a selection procedure for selecting data to be accessed probabilistically from each of the all nodes and deleting the data from the node;
a moving procedure for probabilistically moving data selected in the selection procedure to any of nodes ranging from the root node to the leaf node out of the all nodes, and probabilistically moving data not selected in the selection procedure to any of nodes ranging from a node storing the data to the leaf node; and
a node reply procedure for replying the all nodes to which data are moved, to the server device in order to reflect the all nodes on the complete binary tree.

9. The data access system of claim 1, wherein all data is randomly stored in any one of the leaf nodes as a pair with auxiliary information.

10. The data access system of claim 9, wherein the auxiliary information comprises height and position to each piece of data assigned by the client device.

11. The data access system of claim 10, wherein the position is a value indicating the position from left in the height to which the one of the nodes belongs.

12. The data access system of claim 1, wherein all N pieces of data are randomly stored in one of the leaf nodes.

13. The data access system of claim 1, wherein a probability of outputting the data is ½^{L-i-c}.

14. The data access system of claim 13, wherein the probability is further determined by taking a number of the leaf nodes linked to a node where data is to be stored.
